(19) United States
(12) Patent Application Publication
(10) Pub. No.: US 2024/0256904 A1
(43) Pub. Date: Aug. 1, 2024

(54) SEMI-LOCAL MODEL IMPORTANCE IN FEATURE SPACE

(71) Applicant: THE TORONTO-DOMINION BANK, TORONTO (CA)

(72) Inventors: Kin Kwan Leung, Toronto (CA); Saba Zuberi, Toronto (CA); Maksims Volkovs, TORONTO (CA); Jianing Sun, Toronto (CA)

(21) Appl. No.: 18/425,822

(22) Filed: Jan. 29, 2024

Related U.S. Application Data
(60) Provisional application No. 63/441,918, filed on Jan. 30, 2023.

(51) Int. Cl. G06N 5/01

(52) U.S. Cl. CPC G06N 5/01

(57) ABSTRACT

To provide explanations for black box computer models, data samples are processed by the model to determine related feature attributions for each data sample, describing the extent to which feature values affect the model predictions for that data sample. A group of data samples is selected to be explained and the group is clustered into subgroups based on the feature attributions of the data samples. Because explanations related to feature attributions can be difficult to interpret or relate to input features, each of the subgroups is then described in the feature space, enabling ready interpretation of the groups at a semi-local level.

### CROSS-REFERENCE TO RELATED APPLICATION

This application claims the benefit of provisional U.S. application No. 63/441,918, filed Jan. 30, 2023, the contents of which is incorporated herein by reference in its entirety.

### BACKGROUND

This disclosure relates generally to understanding computer model feature importance and more particularly to semi-local explanations in feature space.

Modern, complex computer models can include a large number of layers that interpret, represent, condense, and process input data to generate outputs. While the complexity of these models is often beneficial in improving a model's outputs with respect to a desired learning objective, the complexity may be a severe drawback for human understanding of the relationship between model inputs (e.g., an individual data instance) and the output. As the complexity of the models increases, the processing and functions within may become more and more difficult to interpret, particularly as the effective function between inputs and outputs may vary significantly according to the region of the input space in which the model forms a prediction, also termed an output.

Explaining predictions of machine learning models is increasingly important given their wide-spread use. Explanations provide transparency and insights into the data, which in turn aids reliable decision making. This is especially important in high-risk domains such as finance and healthcare. The scope of the model explanations provided have to adapt to the specifics of the application in order to be useful. Existing algorithms are typically either global, with explanations that help understand the model structure overall, or local, providing insights for individual examples, such as a patient treated by a clinician or a customer applying for a loan. However, there is an important area of “semi-local” explanations that remains under-explored.

Semi-local explanations identify subgroups with similar reasons for model predictions and generate explanations that distinguish between groups. While both local and global scopes of explanations are important, in real-world settings, understanding the mechanisms in the data at a subgroup level are often critical to make model outputs actionable. The insights generated by semi-local explanations complement rather than replace those provided by local and global explanations.

For example, consider a model predicting diabetes onset using administrative data for the purpose of allocating public health resources. Since the drivers for diabetes onset can vary and require different intervention strategies, an accurate prediction at the individual level and global explanations for the model as a whole are not sufficient to inform policy that may depend on identifying the separate groups of users predicted as high-risk. Identifying subgroups with different drivers in the data may be essential to effectively treating different explanations for the groups. In the diabetes onset example, different subgroups may correspond to similar explanations such as “sedentary lifestyle,” “genetic risk Type I diabetes,” or “gestational diabetes,” that may not currently be identifiable from model explanations.

### SUMMARY

Effective interpretation of model explanations require explanations that are based on the reasons for the underlying model predictions and are easily interpretable. In addition, the model explanations should be applicable to smaller groups of data samples and identify subgroups sharing similar attributions.

To do so, a model analysis system provides semi-local explainability that both identifies subgroups with similar explanations for model predictions and generates explanations in the form of simple rules that are easily interpretable by domain experts. Initially, a group of data samples of interest are identified, which may be a portion of all data samples available for the model, such as the data samples with a particular predicted output value (e.g., a top percentage, prediction over a threshold value, or top N data samples). Then, attributions for the model predictions with respect to each data sample are generated, describing the features that are particularly relevant to the prediction by the model. The data samples in the group are clustered into subgroups based on the model attributions. In this way, subgroup identification is based on feature attributions, connecting subgroup identification to the underlying model explanations. While this selects the relevant data samples for each group, the description of the subgroups is learned with respect to the original feature space rather than the attribution space, enabling the descriptions of the subgroups to be readily interpretable as a portion of the feature space.

The different subgroups thus are determined based on the model attributions for features but are described with respect to the features. The feature descriptions (e.g., definitions as one or more rules) may then be used to characterize the subgroups and may be used to understand characteristics in common for those users, enabling actions or other interventions to be tailored to the subgroup. Thus, one of the data samples in a cluster (or a new data sample) may be within a region defined by the subgroup and associated with the action for the subgroup. This approach provides semi-local explainability that identifies and generates simple descriptions of subgroups relevant to the model predictions, by investigating the relationship between the separability of the subgroups in feature space and the attribution space.

### BRIEF DESCRIPTION OF THE DRAWINGS

FIG. 1 is an example environment for a model analysis system 100, according to one embodiment.

FIG. 2 is an example data flow for generating feature region descriptions for a set of data samples, according to one embodiment.

FIGS. 3A-3B show examples of data sample subgrouping and feature region descriptions, according to one embodiment.

FIG. 4 is an example flowchart of a process for generating feature region descriptions, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Architecture Overview

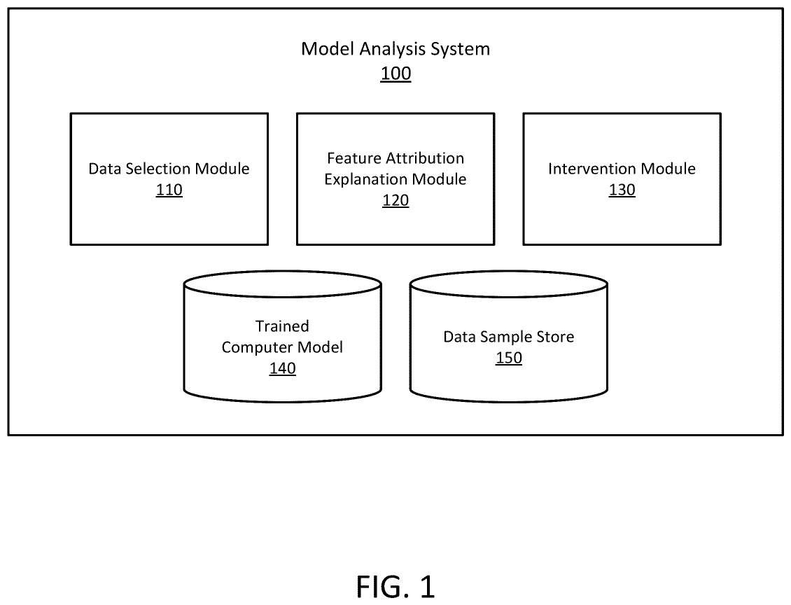

FIG. 1 is an example environment for a model analysis system 100, according to one embodiment. The model analysis system 100 provides model analysis information for understanding and visualizing model predictions. The model analysis may be presented to a user of a client device (not shown) and may communicate with the client device via a network (not shown). The model analysis system 100 includes a trained computer model 140, which may be a computer model that provides an output based on a multi-dimensional (e.g., multi-feature) input. A particular input for the trained computer model 140 is termed a data sample or data instance and includes a plurality of feature values for individual types of features. The multi-dimensional input may be represented as a feature vector, such that each value in the vector represents the feature value of a different feature. While features may be typically described herein as integers or floats for simplicity, in practice, the features may describe characteristics of the data instance with any suitable data type or structure in which the value may be represented with different values, such as a percentage, category types, Boolean values, etc. The individual features of the feature vector may thus be represented in the feature vector with the corresponding data type which may differ across the individual features. The computer model may include various layers to process an input to generate an output according to the structure of the layers and the trained parameters of the trained computer model 140. The various layers may include layers that reduce the dimensionality of the data, determine intermediate representations, and various further processing and functions (e.g., activation functions) for generating an output. In general, these various layers may be difficult for a human user to understand directly, as the trained parameters may not readily be understood with respect to how any particular feature changes outputs of the model and how different regions of an input space are modeled. That is, it may not be apparent how a change in value of particular features (or different regions of feature values across one or more features) affect overall model inference. The model outputs are typically learned based on a training data set from which the model learns to generate outputs based on related outputs for each training data sample. In the examples herein, the computer model output is typically a classification or other predictive task in which the model output may range from zero to one for one or more output types (e.g., classes). In additional embodiments, the computer model output may include other types of model outputs that may have different types of output ranges or types.

The model analysis system 100 thus provides various modules and data for a user of the client device to more intuitively understand the relationships between inputs and outputs of the computer model to gain insight into the model whose complexities and parameters may otherwise render it a “black box” without clear explanation of the translation from input to output. The model analysis system 100 may thus analyze the trained computer model 140 to automatically determine subgroups that provide model explanations in feature space based on similar feature importance to model outputs. The model analysis system 100 may also generate various interfaces for display to the user for analyzing, exploring, and understanding the performance of the model. The client device may be any suitable device with a display for presenting the interfaces to a user and to receive user input to navigate the interfaces. As examples, the client device may be a desktop or laptop computer or server terminal as well as mobile devices, touchscreen displays, or other types of devices which can display information and provide input to the model analysis system 100. The various components of the model analysis system 100 may communicate with the user device as discussed below.

In addition to the trained computer model 140, the model analysis system 100 may include a data sample store 150 for exploring the behavior of the model with respect to various data samples in the data sample store 150. The data sample store 150 includes various data samples that may be processed by the model for generating respective outputs. The data sample store 150 may include training data (from which the trained computer model 140 was trained) in addition to validation data (which did not train the model, but for which known labels for evaluating the model's performance may be known) and may include data samples that did not form any part of the training process. In general, different data sets may include data that describes different portions of the feature space for the input feature vector. That is, each of the features may have a number of possible values, and each data set may include data instances having different combinations of each feature, such that each data set may include different “regions” of possible values of input data.

The model analysis system 100 includes various computing modules for performing the data analysis of the trained computer model 140, which are briefly described here and further described with respect to the further figures below. The model analysis system 100 includes a data selection module 110 for selecting a data group for analysis and explanation. The particular data set may be selected by a user of the client device and may be selected from the data sample store 150. The selected data set may be a subset of all data available in the data sample store 150 or may be, e.g., training data, validation data, recently collected data, and so forth. The data selection module 110 may also select a group of data based on the prediction by the computer model, such as the data samples predicted to have a particular output (e.g., above a threshold output value).

A feature attribution explanation module 120 analyzes data samples and trained computer model 140 that processes the data samples to identify and explain subgroups of the selected data samples. To do so, the feature attribution explanation module 120 generates feature attributions for each of the selected data samples to determine the significance of individual features to particular data samples. The data samples are then clustered with respect to the feature attributions to determine subgroups with similar feature attribution characteristics. The subgroups are then described with respect to regions of the input feature space, enabling description of subgroups with a common feature attribution in the feature space. A feature region description may also be illustrated to the user as visualization in the feature space or as a set of rules defining the region.

In some embodiments, the model analysis system 100 may use an intervention module 130 to apply actions and/or interventions to data samples associated with particular subgroups. The subgroups may indicate groups of data samples sharing similar underlying characteristics and reasons for model predictions that can be associated with similar actions or other interventions. For example, in many cases the outcome of the trained computer model 140 is a prediction of a particular outcome or event in the future based on a set of characteristics or other information about an individual or other entity. Examples include predictions of health outcomes (e.g., diabetes onset, heart disease, all-cause mortality), financial outcomes (credit default), or events in other domains. As such, while the model may predict a particular risk, an appropriate action or intervention may be anticipated to change the actual risk for the individual (represented to the model as a particular data sample). Thus, the subgroups may be used to identify subgroups that are explainable relatively simply in the feature space and that policy makers can use to establish actions associated with respect to the individual subgroups. For example, in the diabetes onset example, the model may predict the likelihood of diabetes onset, while the subgroups may automatically identify subgroups corresponding to type 1 diabetes, lifestyle-related factors, gestational factors, and so forth, each of which may then be associated with different actions.

The particular action for a subgroup may be determined by an administrator or other user of the system, or may be determined based on model predictions, for example, to identify features that can be modified to change the user's membership in the subgroup (e.g., to subsequently belong in no subgroup, corresponding to exiting the group of data samples with a high prediction). For example, if a subgroup is defined by a patient's blood pressure higher than a threshold value, the action may be a recommendation or other treatment to reduce the blood pressure below that value. In many cases, such as medical guidance, relatively simple guidance may be preferred for recommending future patient behaviors or medical interventions, such that simple descriptions of subgroups in the feature space and related actions may be effective approximations for more complex analysis by a computer model, particularly when it may be impractical or ineffective to generate complete information for a patient for use as a complete data sample for input to the computer model.

As such, in some embodiments, the intervention module 130 determines an association of a data sample with a subgroup based on the feature region descriptions and can automatically provide an action or intervention based on the subgroup. In some embodiments, the data sample may also be applied to the trained computer model 140 to verify that the output of the model is consistent with the subgroup. For example, when the subgroup is associated with cardiovascular risk and a patient's features are within a feature region description for the subgroup, the trained computer model 140 may be applied to confirm the actual model prediction for cardiovascular risk of that patient. Because the subgroup definitions may include some approximation and simplification relative to the trained computer model 140, the trained computer model 140 may be applied to confirm the output value when a data sample is associated with a region of a subgroup. Using the association with a subgroup for a data sample and optionally in conjunction with the model output, an action may be performed based on the associated subgroup.

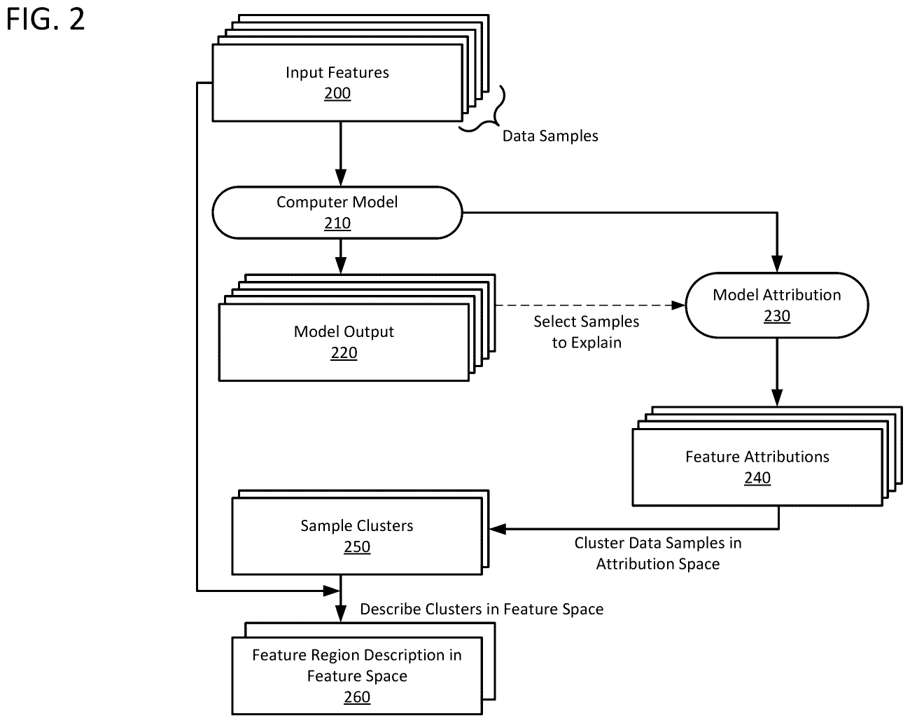

FIG. 2 is an example data flow for generating feature region descriptions for a set of data samples, according to one embodiment. A computer model 210 uses a set of parameters that may be applied to input features 200 for one or more data samples to generate corresponding model outputs 220. More formally, the parameters of the computer model 210 may represent a function for inputs in input domain D to one or more outputs in output domain y:f: [symbol] → [symbol] , where input domain D may have d different features (e.g., d dimensions in the input domain, each of which may have different values). For real-valued features, the input domain may thus be defined as : [symbol] ⊂ [symbol] ^{d}. The outputs may also include a plurality of outputs, for example, representing different classes C, and in some embodiments, each output value for a respective class can represent a probability value for that class. Although examples herein may refer to a single output or single class, in additional embodiments, multiple classes or other types of outputs may be used.

As also discussed above, a group of data samples may be selected for explanation of model predictions. The selection of data samples may be coordinated by the data selection module 110. In some embodiments, the selected group of data samples may be selected by a user and may also be the group of all data samples, in a batch or in a set of training data, or otherwise of interest. In further embodiments, the selected group of data samples may be selected based on a characteristic of the input features 200 (e.g., a value or value range of a particular feature) or may be based on the predicted model outputs 220. In the example shown in FIG. 2, the selected data samples are based on model outputs 220, for example, to select the data samples having a particular output value or an output value above a threshold. The selected data samples may also include data samples selected based on a statistical analysis of the model output values, such as the data samples above the 80^{th} percentile selected with respect to a median or mode of the model outputs 220. The selected data samples may be referred to as a “group” being evaluated for explanation by the model.

In the example of FIG. 2, four of the data samples are selected for explanation. A model attribution 230 step generates a set of feature attributions 240 that describe the respective contribution of the input features 200 to the model output 220. The model attribution 230 may be performed with various algorithms, such as LIME, LRP, DeepLIFT, Integrated Gradients, Shapley values, Grad-CAM, and Deep Taylor Decomposition, and generate feature attribution or saliency maps for the input features of each data sample. As such, the feature attributions 240 generally provide, for individual data samples, an indication of the contribution or sensitivity of the computer model 210 to the corresponding model output 220 for a data sample.

The model attribution 230 may be represented as a function of the computer model 210 and designated of that determines an attribution space A. Formally, the attribution space may generate attributions for each of the input features of a data sample and for each output (e.g., for output classes ϕ_{f} such that the feature attributions 240 may be values across input feature dimensions and outputs: A⊂ [symbol] ^{d×C}. In various embodiments, the feature attributions 240 may be determined with respect to a single output of interest of the computer model 210 (e.g., C=1), rather than multiple outputs.

The selected data samples may then be clustered with respect to the feature attributions 240 to determine a plurality of subgroups describing data samples having similar feature attributions in the feature attribution space (i.e., in A). The selected data samples may be clustered based on the feature attributions generated in various ways as also discussed above, such as Shapley values, integrated gradient, and Deep-LIFT. Clustering may be performed with any suitable clustering algorithm, such as K means and its variants or hierarchical clustering. The clustering in some embodiments may also implement a “completeness” requirement that components of the attribution algorithm lie in the same output space, which may be defined as:

$${\sum }_{j} {{ϕ}_{f} ( x )}_{j c} + {B}_{c} = {f ( x )}_{c} \qquad Equation 1$$

in which j is a feature type;
ϕ_{f} is a model attribution function;
ϕ_{f}(x)_{jc} is a model attribution for data sample x with respect to feature j and model output class c:
B_{c} is a value independent of x; and
f(x)_{c} is the model output for data sample x with respect to model output class c.

The clustering algorithm may determine a number of clusters K simultaneous with cluster assignment (i.e., a cluster assignment algorithm G) or may perform these steps sequentially, depending on the clustering algorithm. As one example, a hierarchical clustering algorithm may be used to determine K and G at the same time, or an algorithm such as KMeans may be used for a range of values of K to select an optimal number of clusters K (based, e.g., on a silhouette coefficient).

As such, the clustering may combine data samples having similar feature attributions 240 to a smaller number of sample clusters 250. While the feature attributions 240 describe the respective importance/impact of the features on the model predictions, the importance of particular features may be difficult to effectively describe for interpretation and may also require application of the model attribution 230. The sample clusters 250, which may be considered subgroups of the selected group of data samples, are then analyzed to describe the respective input feature space for each cluster, such that the clusters may be described as areas or regions of the input feature space. The feature region descriptions 260 may take the form of boundaries or other bounding areas of the input space, and in some embodiments, is a set of rules describing feature values. The rules may be determined, for example, by training a decision tree, such that the feature regions represent the rules learned by the decision tree for defining the subgroups. As examples, such rules may describe a subgroup that may specify a feature value lower than 0.4, a feature value between 0.3 and 0.8, or a feature that has a first class instead of a second class.

Compared to approaches that aggregate feature attributions to provide a list of important features, explanations in the form of ranges of feature values, or “rules”, are more interpretable. The feature region descriptions are thus in features space D instead of the feature attribution space A in which the clusters (subgroups) were generated. Providing rules on feature values rather than simply important feature names can give valuable insights to decision makers. For example, the rule being “Weekly Exercise <50 m” is much more useful to describing a subgroup than simply identifying “Weekly Exercise” as important to the model.

In one embodiment, for each cluster k∈{1, . . . , K}, a description generation algorithm H outputs a rule set Sₖ for cluster k in disjunctive normal form (OR-of-ANDs). For numerical features, the literal would be of the form “FEATURE 2<5” or “10<FEATURE 3<20”. For categorical features, if the feature is one-hot encoded, instead of showing “FEATURE 3: CAT A>0.5”, the feature may be evaluated with a Boolean expression such as “FEATURE 3==A”. Each rule can be represented by Dₖ, a region in the input feature domain D, which is a product of intervals (i.e., the region constrained by the combination of rules of different feature types.)

The feature region description 260 may be generated in various ways in various embodiments, including based on decision trees and decision rule sets. The feature region description 260 should capture the characteristics of the respective cluster while minimizing the number of data samples from other clusters (subgroups) and data samples that were not selected for explanation (i.e., in addition to distinguishing individual clusters, the feature region descriptions 260 also distinguish from other data samples in a corpus.) For example, when the selected data samples include the data samples having a predicted output above a threshold, the region should be defined optimize excluding data samples that were below the threshold along with data samples that belong to other subgroups. Thus, the set of data points in X that satisfies the rule set Sₖ for subgroup k should closely approximate the data points in the subgroup, Xₖ.

In one embodiment, an auxiliary decision tree classifier is trained to capture the correspondence between attribution and feature space. For each cluster, k, a decision tree is trained of depth dₘₐₓ for a subgroup with respect to all of X using the binary classification objective in a one-vs-all fashion with cluster assignments as labels (to discriminate the subgroup from other subgroups and other data samples). Each node at depth d corresponds to a conjunction of d literals. This approach aims to choose a unique node whose rules maximize the Jaccard index for cluster k. For node i, pᵢ is the number of data points in the node that belong to cluster k and nᵢ is the number of points in the node that do not. The Jaccard index for cluster k and node i is pᵢ/(|Xₖ|+nᵢ), where |Xₖ| are the number of data points in the cluster. The Jaccard index may thus describe the number of data samples of the cluster described by the rule (i.e., the particular node) relative to the total number of data points in the cluster and non-cluster data points described by the rule. Choosing a unique node will make sure that the rule set Sₖ consists of only 1 rule.

There is a trade-off between the cluster description performance and its interpretability. Increasing the complexity of Sₖ improves the ability of the rules to approximate the data samples in the subgroup at the expense of more difficult interpretability (e.g., by human interpreters). In some embodiments, the complexity of the rules (e.g., the maximum number of rules) for defining a feature region description is specified by an operator; in other embodiments the level of rule complexity may be evaluated against the error rate (e.g., data samples incorrectly included or rejected) for a particular rule complexity. However, by converting clustered feature attributions to feature space, regions of the input space corresponding to different subgroups having similar feature attributions by the model may be more easily identified and evaluated.

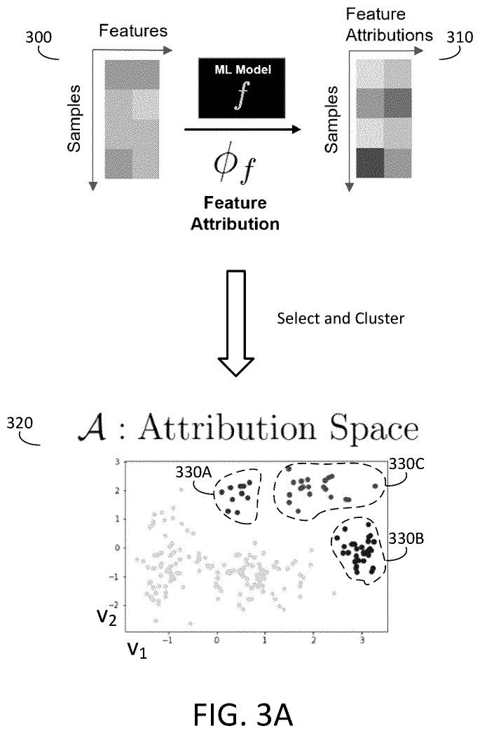

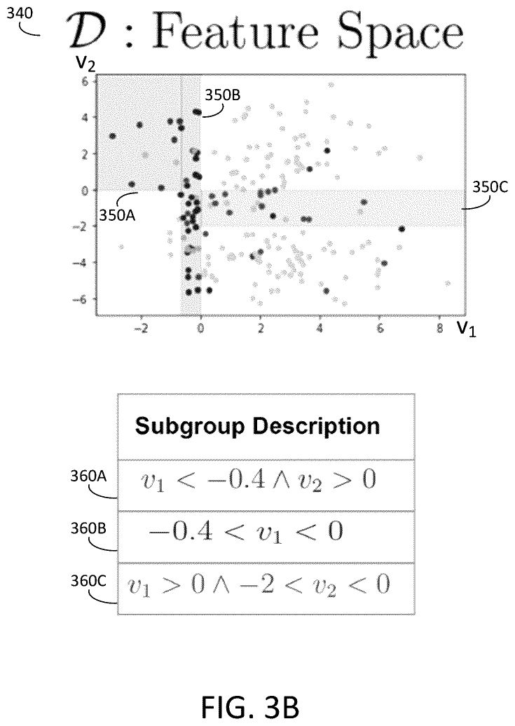

FIGS. 3A-3B show visual examples of data sample subgrouping and feature region descriptions, according to one embodiment. In this example, each data sample has two features, labeled v1 and v2. Each of the data samples includes different values of the features as illustrated by in the gradation in the illustrated data sample table 300. As discussed above, the feature attributions 310 for each of the data samples with respect to each of the features is generated with a feature attribution ϕ_{f} applied with respect to the model f.

After selecting a group of data samples to be explained, the groups are clustered with respect to the feature attributions 310, yielding three subgroups 330A-C as illustrated in attribution space 320. Although shown with dotted lines and referenced as portions of the attribution space 320, the data samples of each subgroup 330A-C are associated with the individual subgroups and no region may be defined in the attribution space. That is, the clustering identifies particular data samples to associate together as subgroups but may not expressly define any region for inclusion or exclusion of the data samples. Instead of describing the subgroups as regions of the attribution space 320, the regions are defined as portions of the feature space 340 as shown in FIG. 3B. In this example, the learned feature region description 350A-C for each subgroup is based on a decision tree learning a union of disjoint rules.

Where the attribution space 320 shows the significance of particular features in affecting model outputs, the learned interpretation in feature space illustrates the range of feature values corresponding to the subgroups. In this example, subgroup regions 350A-C correspond to subgroups 330A-C. As shown in this illustration, where subgroup 330A can be interpreted in attribution space 320 as a relatively low attribution of v1 and high attribution of v2, in the feature space 340 the corresponding learned region describes values below 0.4 for feature v1 and above zero for feature v2. The subgroup regions 350A-C shown in feature space 340 may also be represented as the corresponding definitions 360A-C for each subgroup, enabling simple understanding of the subgroup definitions.

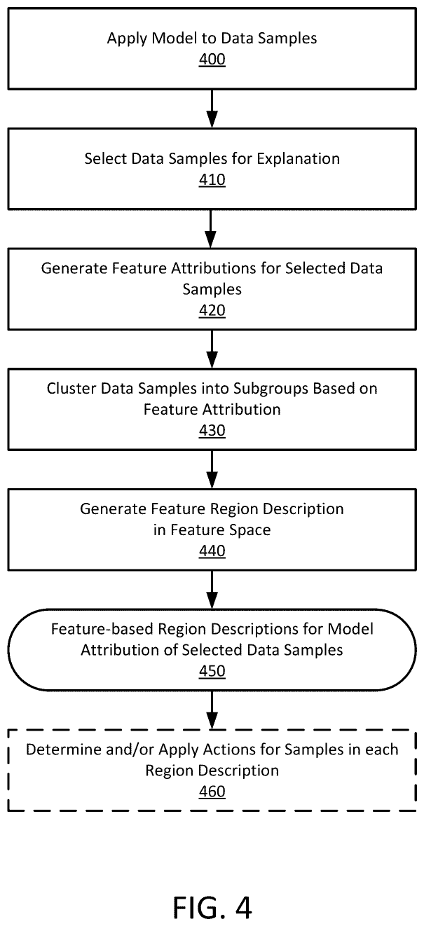

FIG. 4 is an example flowchart for a process for generating feature region descriptions, according to one embodiment. The process of FIG. 4 may be performed, for example, by a model analysis system as shown in FIG. 1. Initially, a model to be explained is selected and applied 400 to a number of data samples to determine model outputs, and a group of data samples selected 410 for explanation. As discussed above, the selected data samples may be based on the model predictions. Using a feature attribution function, the feature attributions are generated 420 for each of the selected data samples describing the contribution of the various features to the model output. The selected data samples in the group are then clustered 430 to subgroups based on the feature attributions, such that data samples having similar attributions for model predictions are grouped together.

After identifying the subgrouping, the subgroups are then explained with respect to the feature space by generating 440 feature region descriptions of the subgroups. As discussed above, the feature region descriptions may be relatively simple definitions of the subgroups, enabling interpretation of the subgroups with respect to the feature values of the data samples, rather than what features were significant to the model. This results in a set of feature-based region descriptions 450 that may be used to understand the model and may also be used to determine actions or other policies based on the subgroups. When the feature region descriptions describe a combination of simple disjoint rules (e.g., v1 is greater than 0.5 and v2 is between 0.2 and 0.8), the subgroups can be easily understood, and related actions determined.

In some embodiments, actions may be associated with or determined 460 for the subgroups to be applied to data samples that are members of the subgroup. This may enable the subgroup definitions to operate as a simplified interpretation of the overall model via the region descriptions as discussed above, particularly when the selected group of data samples was selected based on a model output value (e.g., data samples having model outputs above a threshold).

As such, the sometimes-opaque behavior of various computer models can be effectively understood and explained with respect to portions of the input space that share similar reasons for model behavior. This provides semi-local explanations at the subgroup level describable with respect to input features. This is particularly relevant for applications where actions are taken at a subgroup, rather than individual level and complement global explanations. This also provides a mechanism for automatically applying actions based on subgroup region descriptions in the feature space. In addition, this provides quantitative evaluation of the quality of our descriptions, which builds trust and could assist in the decision-making process by uncovering more insights. As machine learning algorithms become more common in regulated domains, this will benefit the effective deployment of these models and earn trust from domain practitioners that may otherwise be reluctant to trust model predictions that lack explainable behaviors as feature values.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A system comprising:
a processor configured to execute instructions;
a non-transitory computer-readable medium containing instructions executable by the processor for:
generating a feature attribution with respect to an output of a computer model relative to input features for each data sample of a group of data samples;
clustering the group of data samples into a plurality of subgroups based on the respective feature attribution of each data sample; and
generating a feature region description in feature space with respect to input features for a subgroup of the plurality of subgroups.

2. The system of claim 1, wherein the group of data samples is a subset of a set of data samples and the feature region description is determined with respect to the subgroup relative to the set of data samples.

3. The system of claim 1, wherein the feature attribution is determined based on LIME, LRP, DeepLIFT, Integrated Gradients, Shapley Values, Grad-CAM, or Deep Taylor Decomposition.

4. The system of claim 1, wherein the feature region description describes one or more rules with respect to one or more input features.

5. The system of claim 1, wherein the feature region description is determined by training a decision tree with respect to membership in the subgroup.

6. The system of claim 1, wherein the instructions are further executable for:
determining that a data sample is a member of a subgroup based on the feature region description;
identifying an action associated with the subgroup; and
performing the action for the data sample.

7. The system of claim 1, wherein the instructions are further executable for providing a visualization for display to a user device, the visualization showing the feature region description relative to the group of data samples.

8. A method, comprising:
generating a feature attribution with respect to an output of a computer model relative to input features for each data sample of a group of data samples;
clustering the group of data samples into a plurality of subgroups based on the respective feature attribution of each data sample; and
generating a feature region description in feature space with respect to input features for a subgroup of the plurality of subgroups.

9. The method of claim 8, wherein the group of data samples is a subset of a set of data samples and the feature region description is determined with respect to the subgroup relative to the set of data samples.

10. The method of claim 8, wherein the feature attribution is determined based on LIME, LRP, DeepLIFT, Integrated Gradients, Shapley Values, Grad-CAM, or Deep Taylor Decomposition.

11. The method of claim 8, wherein the feature region description describes one or more rules with respect to one or more input features.

12. The method of claim 8, wherein the feature region description is determined by training a decision tree with respect to membership in the subgroup.

13. The method of claim 8, the method further comprising:
determining that a data sample is a member of a subgroup based on the feature region description;
identifying an action associated with the subgroup; and
performing the action for the data sample.

14. The method of claim 8, the method further comprising providing a visualization for display to a user device, the visualization showing the feature region description relative to the group of data samples.

15. A non-transitory computer-readable medium comprising instructions that, when executed by a processor, cause the processor to:
generate a feature attribution with respect to an output of a computer model relative to input features for each data sample of a group of data samples;
cluster the group of data samples into a plurality of subgroups based on the respective feature attribution of each data sample; and
generate a feature region description in feature space with respect to input features for a subgroup of the plurality of subgroups.

16. The non-transitory computer-readable medium of claim 15, wherein the group of data samples is a subset of a set of data samples and the feature region description is determined with respect to the subgroup relative to the set of data samples.

17. The non-transitory computer-readable medium of claim 15, wherein the feature attribution is determined based on LIME, LRP, DeepLIFT, Integrated Gradients, Shapley Values, Grad-CAM, or Deep Taylor Decomposition.

18. The non-transitory computer-readable medium of claim 15, wherein the feature region description describes one or more rules with respect to one or more input features.

19. The non-transitory computer-readable medium of claim 15, wherein the feature region description is determined by training a decision tree with respect to membership in the subgroup.

20. The non-transitory computer-readable medium of claim 15, wherein the instructions further cause the processor to:
determine that a data sample is a member of a subgroup based on the feature region description;
identify an action associated with the subgroup; and
perform the action for the data sample.
